(19) United States
(12) Patent Application Publication
(10) Pub. No.: US 2021/0229816 A1
(43) Pub. Date: Jul. 29, 2021

(54) ELECTRONIC HOUSING FOR AIRCRAFT

(71) Applicant: Lufthansa Technik AG, Hamburg (DE)

(72) Inventors: Viktor Daubner, Hamburg (DE); Karl Bock, Hamburg (DE); Frank Niss, Hamburg (DE)

(21) Appl. No.: 17/264,855

(22) PCT Filed: Aug. 6, 2019
(86) PCT No.: PCT/EP2019/071118

§ 371 Date: Feb. 1, 2021

(30) Foreign Application Priority Data
Aug. 7, 2018 (DE) 10 2018 119 130.8

(51) Int. Cl. B64D 11/06

(52) U.S. Cl. CPC B64D 11/0696; B60N 2002/0264; B64D 11/0624

(57) ABSTRACT

An electronic housing houses electronics for an aircraft. The electronic housing has an outer wall surrounding an electronic receiving compartment; and fasteners on one side of the outer wall on an outer side. The fasteners are configured to engage in a snap-fit connection to a predefined raceway configured for the attachment of a cover by a snap-fit connection.

### CROSS-REFERENCE TO PRIOR APPLICATIONS

This application is a U.S. National Phase Application under 35 U.S.C. § 371 of International Application No. PCT/EP2019/071118, filed on Aug. 6, 2019, and claims benefit to German Patent Application No. DE 10 2018 119 130.8, filed on Aug. 7, 2018. The International Application was published in German on Feb. 13, 2020, as WO 2020/030637 under PCT Article 21(2).

### FIELD

The present invention relates to an electronic housing for aircraft and to an arrangement of a corresponding housing in the aircraft.

### BACKGROUND

Particularly in the case of older aircraft, there may be a need for additional electronics to be provided in the aircraft cabin and, in particular, in the region of the passenger seats, in order to improve passenger comfort and service. One example of corresponding electronics is the provision of charging devices with USB ports by means of which passengers can charge their mobile terminals during a flight.

Additional electronics can be housed in the wall paneling of the passenger cabin, for example. The disadvantage of this is the complex installation which routinely also requires the creation of cable runs for the power supply to the electronics. As an alternative to this, the electronics can be fastened straight onto the seat, although this is regarded as a seat modification which requires time-consuming and costly new approval of the seat for aeronautical purposes.

The electronics may also be arranged in boxes, which can be fastened to the seat rail to which the seat is also fastened. Corresponding boxes must be designed in such a manner that they can still be fitted to, and removed from, the seat rail even when the seats are installed. Experience has shown that corresponding boxes severely restrict foot space for passengers on account of the shape required for fitting and removal, as they project far beyond the supporting structure of the seat.

### SUMMARY

In an embodiment, the present invention provides an electronic housing that houses electronics for an aircraft. The electronic housing has an outer wall surrounding an electronic receiving compartment; and fasteners on one side of the outer wall on an outer side. The fasteners are configured to engage in a snap-fit connection to a predefined raceway configured for the attachment of a cover by a snap-fit connection.

### BRIEF DESCRIPTION OF THE DRAWINGS

Embodiments of the present invention will be described in even greater detail below based on the exemplary figures. The present invention is not limited to the exemplary embodiments. All features described and/or illustrated herein can be used alone or combined in different combinations in embodiments of the present invention. The features and advantages of various embodiments of the present invention will become apparent by reading the following detailed description with reference to the attached drawings which illustrate the following:

FIGS. 1-2 show a first exemplary embodiment of an electronic housing according to the invention; and

FIGS. 3a-3c show the assembly of a second exemplary embodiment of an electronic housing according to the invention.

### DETAILED DESCRIPTION

Embodiments of the present invention provide an electronic housing for aircraft, in particular for the passenger cabin of an aircraft, in which the disadvantages known from the prior art no longer occur, or only occur to a lesser extent.

Consequently, embodiments of the present invention relate to an electronic housing for aircraft having an outer wall surrounding an electronic receiving compartment, wherein the housing comprises, on one side of the outer wall on the outer side, fastening elements for snap-fit connection to a predefined raceway designed for the attachment of a cover by means of a snap-fit connection.

Embodiments of the present invention furthermore relate to an arrangement comprising an aircraft seat fastened by its seat structure to at least one seat rail, to a raceway extending along the seat rail, and to an electronic housing according to the invention, wherein the electronic housing is fastened to the raceway by its fastening elements in the region of the seat structure.

A number of terms used in connection with the invention are explained to begin with.

A “seat rail” refers to elongate elements routinely arranged on the floor of aircraft cabins to which individual aircraft seats or groups of aircraft seats—for example aircraft seats rigidly connected to form rows of seats—can be anchored by their seat structure. The seats in this case can be routinely fastened in virtually any position which is frequently only limited by a possible snap-fit connection of the seat rail in the longitudinal direction of the aircraft, so that the distance between two seats arranged behind one another—where appropriate in stages predefined by the pattern of the seat rail—can be changed.

A “raceway” is a cable channel laid parallel to the seat rail for conducting cables, which cable channel a channel-shaped floor element fixedly fastened—frequently adhered—to the cabin floor and/or to the seat rail, which floor element can be closed by a cover that can be fastened to the floor element by means of a snap-fit connection. The raceway is used, for example, for holding power supply cables and data cables for electronics, which are permanently installed in the aircraft seats, such as monitors for the inflight entertainment system, for example.

The invention has recognized that additional electronics can be advantageously fastened in the region of aircraft seats to the raceway which frequently exists there. For this purpose, the electronic housing according to embodiments of the invention, in the receiving compartment of which the additional electronics can be housed, has fastening elements on one side with which the electronic housing can engage with the snap-fit elements of the raceway originally provided for the attachment of a cover and thereby be directly fastened. The cover of the raceway then only needs to be provided on either side of the electronic housing. An electronic housing according to the invention can therefore be assembled very easily.

In a preferred embodiment, the fastening elements of the electronic housing can be designed in such a manner that they are able to withstand the emergency landing loads according to CS-25 of the EASA dated 27 Mar. 2018, preferably acceleration loads (also referred to as inertia loads) of 9 g in any direction. In other words, the fastening elements should be designed taking account of a predefined maximum weight for the electronics housed therein in such a manner that the connection between the electronic housing and the raceway does not separate even at accelerations such as those specified in the aforementioned approval regulations, or at accelerations of 9 g—in other words 9-times the earth's acceleration, but withstands the inertial forces occurring in this case. Comparable requirements and test methods for these are furthermore known in the aeronautical sector. If the fastening elements are able to withstand corresponding accelerations, they can of course absorb other loads to a comparable extent too. In particular, they can withstand so-called “misuse” loads which are applied by a passenger kicking the electronic housing, for example, provided the resulting load does not exceed the load to be expected for the aforementioned accelerations.

The outer wall of the electronic housing may preferably have a raceway on the side of the fastening elements. The electronic housing replaces the cover of the raceway with the side in question. Because a raceway is provided in addition on this very side, power supply cables and/or data cables can easily be laid from the raceway into the electronic receiving compartment of the electronic housing.

On the outer side of the outer wall remote from the side with fastening elements, at least one projection for bearing against structural elements of the aircraft, preferably the seat structure of aircraft seats, is provided. The projection or projections is/are used to deflect, at least in part, any loads occurring on the electronic housing in the direction of the bearing surface of a projection into a structural element of the aircraft. If a passenger accidentally kicks an electronic housing arranged in principle in their foot space, for example, the misuse loads resulting from this can be deflected into the structural elements of the aircraft in this very region, which structural elements must be designed in principle to resist corresponding loads. Because the projection, or projections, only lies/lie adjacent to the structural elements, a change in the structural elements of the aircraft seat, for example, is not required. It is not necessary in this case for the projection, or projections, to be immediately adjacent to a structural element, even when the electronic housing is in the unloaded state—in other words, particularly free from so-called misuse loads. Instead, in advantageous embodiments this bearing can also only materialize when a misuse load exists, for example in that the electronic housing is initially easily elastically deformed or moved until the projection, or projections, is/are actually adjacent to a structural element. It is further preferable for this bearing to come about only when a misuse load above a significant size materializes, wherein the significant size preferably corresponds to acceleration loads of 9 g in any direction. In order to avoid noise generation in this case due to the typically impact-like bearing of the projection/projections against structural elements, the projection, or projections, can be provided with cushioned elements.

As an alternative, or in addition to, the projections described, on the outer side of the outer wall remote from the side with fastening elements, a guide element open on one side for gripping around structural elements of the aircraft, preferably of the seat structure of aircraft seats, can be provided. The function of the guide element in this case is basically comparable with that of the projections described, wherein the guide elements can deflect loads in more than one direction, or in at least two directions, due to the gripping-around of a structural element of the aircraft.

In a preferred embodiment, the guide element or guide elements and/or projections can be designed in such a manner as to withstand total loads that correspond to acceleration loads of 100 g in at least one direction. In other words, the at least one guide element, the at least one projection, or any combination of guide elements and projections, should be designed in such a manner that by means of these, loads of 100 g can be deflected into at least one structural element when the electronic housing is in the assembled state. It is unimportant in this case whether corresponding loads are introduced into a structural element by means of a single guide element or a single projection or only by a combination of multiple corresponding elements. These loads may, in particular, be the so-called misuse loads which can be introduced, for example, by kicks against the outer wall of the electronic housing, the incorrect insertion and removal of cables, or inappropriate pulling on the cable.

In a preferred embodiment, the electronic housing may have at least two housing parts, a first housing part of which comprises the fastening elements, and at least one further housing part is hooked to the first housing part and/or tightly screwed thereto. A corresponding division of the electronic housing allows easy assembly. The first housing part can therefore be fastened to the raceway initially and cables guided through the raceway where necessary and connected to the electronics provided for the electronic receiving compartment before the second housing part is fastened to the first housing part. The second housing part in this case may, for example, have projections on one side for engaging with corresponding depressions in the first housing part and, moreover, secured by one or multiple screws to the first housing part.

It is also possible for the electronic housing to comprise three housing parts, of which the first housing part can be fastened by fastening elements to a raceway. The other two housing parts can be hooked to the first housing part by hook elements, for example, and secured in respect of one another by a screw connection.

The electronic housing may hold any electronics in principle. It is preferable, however, for a charging unit to be arranged in the electronic receiving compartment and for at least one charging port to be provided on the outer side of the outer wall remote from the side with fastening elements. In this case, the electronic housing offers passengers the opportunity to charge their mobile terminals, for example, using the outwardly accessible charging port. The charging port is preferably a standardized charging port, for example a USB port. As an alternative, or in addition, a 110 V power supply with ports suitable for this, preferably standardized ports, can also be provided on the outer side of the electronic housing. In possible advantageous embodiments, the electronics can be formed from a USB charging device and/or a 110V power supply for the passenger.

For an explanation of the arrangement according to the invention, reference is made to the preceding remarks.

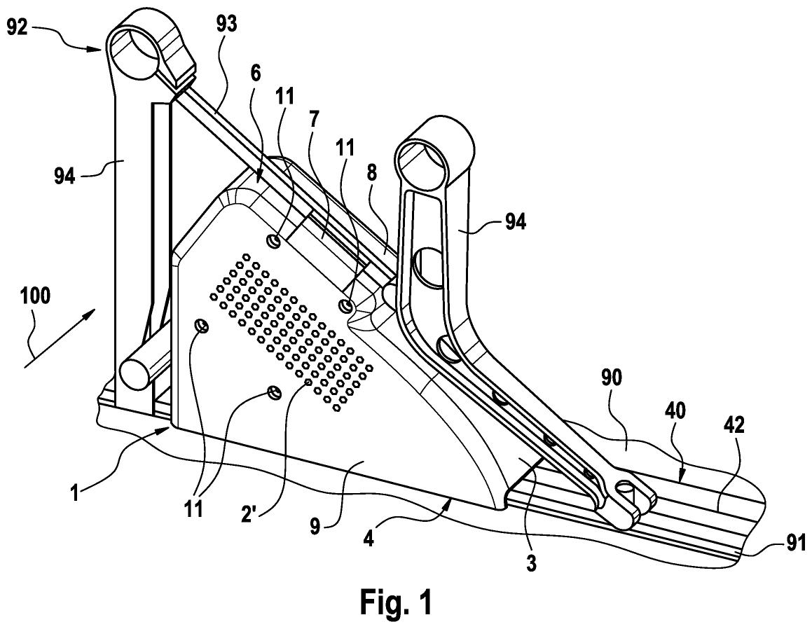

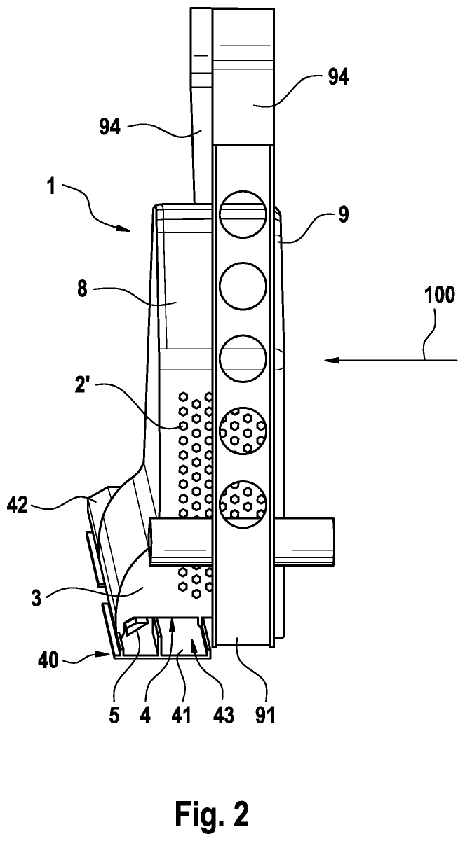

FIGS. 1 and 2 show a first exemplary embodiment of an electronic housing 1 according to an embodiment of the invention in the assembled state. The electronic housing 1 in this case is fastened to the raceway 40 running on the floor 90 of an aircraft cabin alongside a seat rail 91. Aircraft seats are fastened to the seat rail 91. For one of these aircraft seats, the parts of the seat structure 92 comprising two supporting legs 94 connected by a cross member 93 which are directly connected to the seat rail 91 are shown.

The raceway 20 comprises a floor element 41 adhered to the floor 90, which can be closed by a cover 42 that can be fastened to the floor element 41 in a manner known per se by means of a snap-fit connection. A channel 43 for laying cables is provided in the floor element 41.

The electronic housing 1 has, inside an electronic receiving compartment, the ventilation openings 2′, which can be seen in FIGS. 1 and 2. Electronics that are supplied with energy via a cable guided through the channel 43 in the floor element 41 of the raceway 40 are provided in this receiving compartment.

The electronic housing 1 has, on one side 4 of the outer wall 3 on the outer side, fastening elements 5 for snap-fit connection to the raceway 40. With the help of these fastening elements 5, the electronic housing 1 can be fastened by snap-fitting to the floor element 41 in a comparable manner to the cover 42. In this case, the fastening elements 5 are configured in such a manner that based on a predefined permissible maximum weight for the electronics they are able to withstand acceleration loads of 9 g in any direction, which means that the loads for emergency landings according to CS-25 of the EASA dated 27 Mar. 2018 can also be withstood, in particular. In a likewise advantageous embodiment, the fastening elements 5 are configured in such a manner that the emergency landing loads according to FAR-25 of the FAA dated 31 Jul. 2018, in particular, can also be withstood.

A projection 7 with which the electronic housing 1 bears against the cross member 93 of the seat structure 92 of the aircraft seat is provided on the side 6 of the outer wall 3 substantially opposite the side 4. This projection 7 enables the electronic housing 1 to withstand loads of up to 100 g in the direction indicated by the arrow 100. The seat structure 92 need not be changed for this purpose.

The electronic housing 1 has a first housing part 8 on which the fastening elements 5, among other things, are arranged and a second housing part 9 designed as a cover, on which the projection 7 is also located. The second housing part 9 is fastened by screws 10 to the first housing part 8.

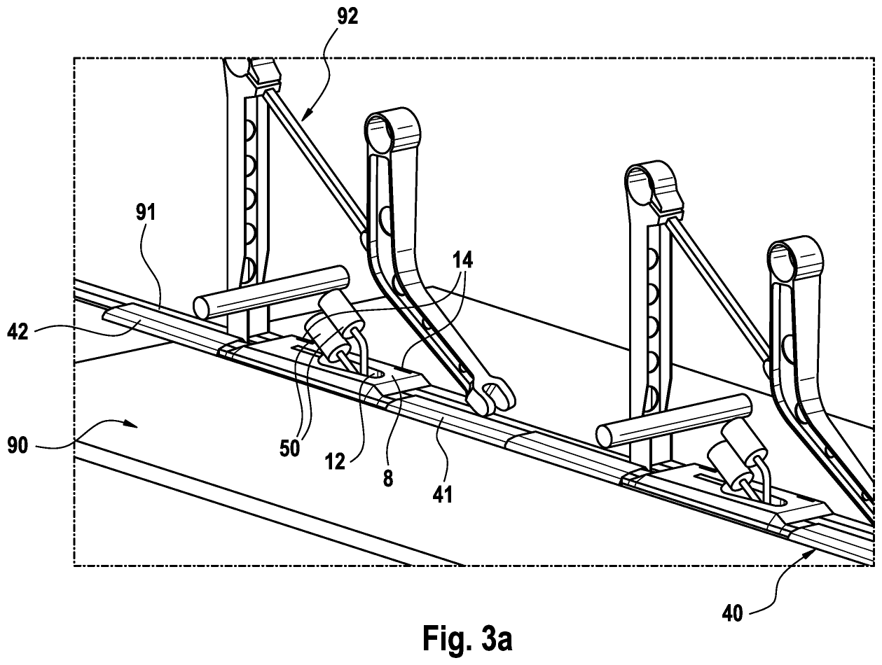

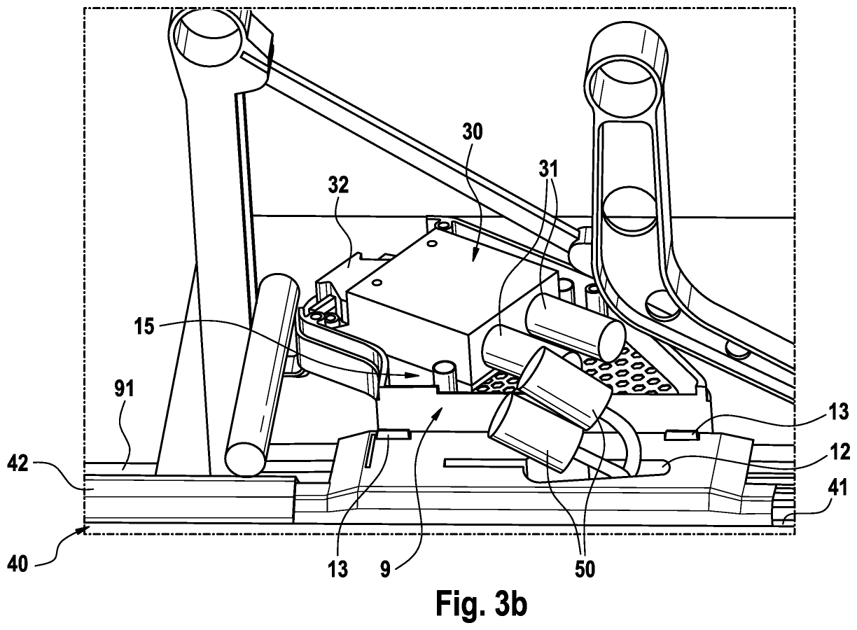

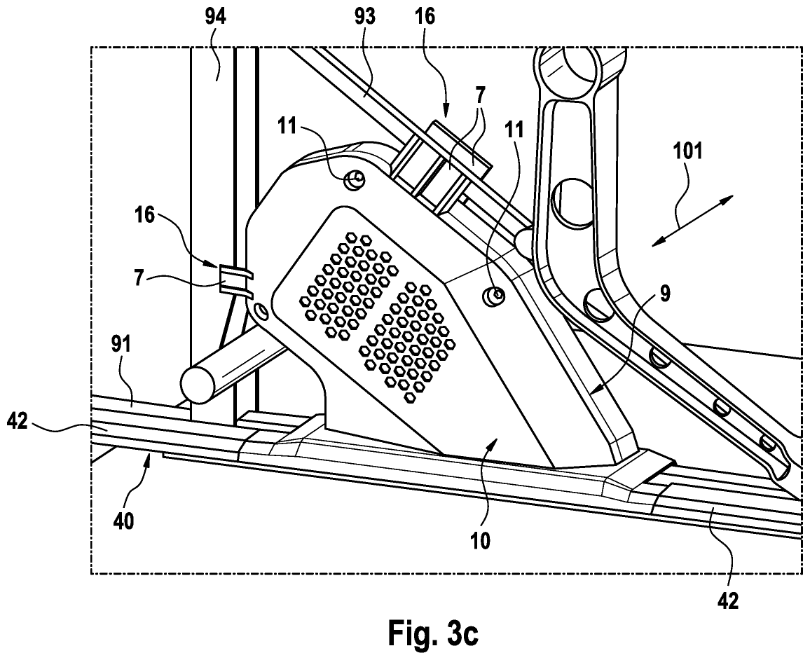

A second exemplary embodiment of an electronic housing 1 according to the invention is depicted in three different assembly stages in FIG. 3a-b. In this case, similarly to FIGS. 1 and 2, the electronic housing 1 in this exemplary embodiment is also fastened by a snap-fit connection to a raceway 40 running alongside a seat rail 91 on the floor 90 of an aircraft cabin, which snap-fit connection can likewise be loaded with 9 g.

The electronic housing 1 comprises a first housing part 8 on which fastening elements 5 comparable to those from FIGS. 1 and 2 are arranged. Before the first housing part 8 is fastened to the raceway 40 with the help of the fastening elements 5, the cables 50 which are needed for energy and data supply to the electronics are conducted through the raceway 11 in the first housing part 8 and therefore on the side of the outer wall 3 of the subsequent electronic housing 1 with the fastening elements 5 (cf. FIG. 3a).

A second housing part 9 is subsequently hooked into openings 14 provided therefor in the first housing part 8 (cf. FIG. 3b) with the help of hook elements 13. Electronics 30 which have plugs 31 for connecting to the cables 50 are arranged in the second housing part 9 in a receiving compartment 2. If the cables 50 are connected to the plugs 31, the second housing part 9 can be pivoted about the axis formed by the hook elements 13 before a third housing part 10 is fastened thereto with the help of screws 11 and thereby closes the electronic holding compartment 2 (cf. FIG. 3c).

Projections 7, which each form pairs of guide elements 16 that are open on one side, are provided both on the second and on the third housing part 9, 10. The two guide elements 16 in this case engage around the seat structure 92—namely of one of the two supporting legs 94 and the cross members 93—in such a manner that the electronic housing 1 withstands loads of up to 100 g in the directions indicated by the double arrow 101, wherein part of the load in each case is absorbed by one of the guide elements 16. Corresponding loads may, in particular, be misuse loads and result from the electronic housing 1 being kicked, for example.

The guide elements 16 furthermore serve to secure the electronic housing 1 in the position shown in FIG. 3c, since the projections 7 on the third housing part 10, in particular, prevent a pivoting back of the second housing part 9 into the position shown in FIG. 3b.

The electronics 30—insofar as they fit in the receiving compartment 2 and the maximum weight for which the electronic housing 1 is designed—may in principle have any design. In the exemplary embodiment according to FIGS. 3a-c, the electronics refer to a USB charger which provides an outwardly accessible USB charging port 32 by means of which passengers can charge their electronic terminals if required.

While embodiments of the invention have been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. An electronic housing for an aircraft, the electronic housing comprising:
an outer wall surrounding an electronic receiving compartment; and
fasteners on one side of the outer wall on an outer side, the fasteners being configured to engage in a snap-fit connection to a predefined raceway configured for the attachment of a cover by a snap-fit connection.

2. The electronic housing as claimed in claim 1, wherein the fasteners of the electronic housing are configured to withstand emergency landing loads according to CS-25 EASA dated 27 Mar. 2018.

3. The electronic housing as claimed in claim 1, wherein the outer wall has a second raceway on the one side with the fasteners.

4. The electronic housing as claimed in claim 1, wherein on the outer side of the outer wall remote from the one side with the fasteners, at least one projection configured to bear against structural elements of the aircraft, is provided.

5. The electronic housing as claimed in claim 1, wherein on the outer side of the outer wall remote from the one side with the fasteners guides open on one side for gripping around structural elements of the aircraft be provided.

6. The electronic housing as claimed in claim 5, wherein the guides are designed to withstand total loads that correspond to acceleration loads of 100 g in at least one direction.

7. The electronic housing as claimed in claim 1, wherein the electronic housing has at least two housing parts, comprising a first housing part on which the fasteners are arranged, and at least one further housing part, which is hooked to the first housing part or tightly screwed thereto.

8. The electronic housing as claimed in claim 1, wherein a charging unit is arranged in the electronic receiving compartment and at least one charging port is provided on the outer side of the outer wall remote from the one side with fasteners.

9. An arrangement, the arrangement comprising
an aircraft seat fastened, by its seat structure to at least one seat rail, to the predefined raceway extending along the seat rail; and
the electronic housing, as claimed in claim 1, wherein the electronic housing is fastened to the predefined raceway by the fasteners in the region of the seat structure.

10. The arrangement as claimed in claim 9, wherein the electronic housing is arranged in such a manner with respect to the seat structure that one or multiple guides and/or projections grip around the seat structure or bear against it.

11. The electronic housing as claimed in claim 1, wherein the fasteners of the electronic housing are configured to withstand acceleration loads of at least 9 g in any direction.
